(19) United States
(12) Patent Application Publication
(10) Pub. No.: US 2012/0051326 A1
(43) Pub. Date: Mar. 1, 2012

(54) RADIO COMMUNICATION SYSTEM, RADIO COMMUNICATION TERMINAL AND COMMUNICATION CONTROLLING METHOD

(75) Inventor: Tomoyoshi Yokota, Kanagawa (JP)

(73) Assignee: Kyocera Corporation, Kyoto (JP)

(21) Appl. No.: 13/258,997

(22) PCT Filed: Mar. 25, 2010
(86) PCT No.: PCT/JP2010/055282

§ 371 Date: Nov. 8, 2011

(30) Foreign Application Priority Data
Mar. 26, 2009 (JP) 2009-077851

(51) Int. Cl. H04W 36/00

(52) U.S. Cl. 370/331; 455/525

(57) ABSTRACT

A video streaming client (105) transmits an MIH_USER_Register.request which requests registration of an entity to an MIHF (Media Independent Handover Function) (103) and an MIHF (203). On the basis of the MIH_USER_Register.request received from the video streaming client (105), the MIHF (103) and the MIHF (203) register an MIH_USER_ID which identifies the entity while associating the MIH_USER_ID with the video streaming client (105), and notify the video streaming client (105) of an MIH_USER_Register.response including the registered MIH_USER_ID.

### TECHNICAL FIELD

The present invention relates to a radio communication system, a radio communication terminal and a communication controlling method which perform handover from a first radio communication network to a second radio communication network employing a radio communication method different from that of the first radio communication network.

### BACKGROUND ART

The recent advancement of radio communication technology has led to implementation of a radio communication system between a mobile communication terminal (Mobile Node), which is capable of establishing connection to multiple radio communication networks employing different radio communication methods, or a mobile router and a mobile communication terminal (Mobile Network Node), which is connected to the mobile router and is joining a mobile network.

Such radio communication system includes: an MIH user (Media Independent Handover User, mobility manager) configured to administrate mobility between multiple radio communication networks; and multiple link controllers each configured to establish a radio link with any one of the radio communication networks.

Proposal has been made to include an MIH function (Media Independent Handover Function, handover controller) between an MIH user and multiple link controllers in such radio communication system capable of establishing connection to multiple radio communication networks, the MIH function being configured to control handover between the radio communication networks, i.e., inter-system handover (non-patent document 1, for example).

### PRIOR ART DOCUMENT

### Non-Patent Document

Non-patent document 1: IEEE P802.21/D04.00 Draft IEEE Standard for Local and Metropolitan Area Networks: Media Independent Handover Services, LAN MAN Standards Committee of the IEEE Computer Society

### SUMMARY OF THE INVENTION

The method described in the above non-patent document 1 assumes that a single MIH user and a single MIH function (handover controller) perform communication, specifically, receive and transmit commands and events. However, in reality, each entity, such as an application (an IP phone, for example), may function as an MIH user. In this case, a situation may occur in which multiple MIH users exist for a single MIH function.

If multiple MIH users exist for a single MIH function as described above, the MIH function cannot identify the multiple MIH users (entities), resulting in a problem that communication between the MIH users and the MIH function is impossible.

The present invention has been made in view of such situation, and has an objective to provide a radio communication system, a radio communication terminal and a method for controlling communication which are capable of enabling a handover controller, such as an MIH function, to definitely and reliably perform communication with each MIH user even when multiple MIH users exist for a single handover controller.

To solve the above problem, the present invention has following features. First, a first feature of the present invention is summarized as a radio communication system (radio communication system 50) which performs handover from a first radio communication network (radio communication network 10, for example) to a second radio communication network (radio communication network 20, for example) employing a radio communication method different from the radio communication method of the first radio communication network, including: a link controller (link controller 205) configured to establish a radio link (radio link RL) with the first radio communication network or the second radio communication network; a plurality of entities (video streaming client 105 and video phone 107, for example) each configured to use at least one of the first radio communication network and the second radio communication network; and a handover controller (MIH Function 103, MIH Function 203) configured to control handover from the first radio communication network to the second radio communication network on the basis of a request from any one of the entities, wherein each of the entities transmits a registration request (MIH_USER_Register.request) which requests registration of the entity, to the handover controller, the handover controller registers the entity which has transmitted the registration request and an entity identifier (MIH_USER_ID) which identifies the entity, while associating the entity with the entity identifier, on the basis of the registration request received from the entity, and the handover controller notifies the entity which has transmitted the registration request, of the registered entity identifier (MIH_USR_Register.response).

In such radio communication system, receiving a registration request from a certain entity such as a communication application, the handover controller registers the entity and the entity identifier which identifies the entity, while associating the entity with the entity identifier.

Accordingly, even when entities such as communication applications each function as an MIH user and hence multiple MIH users exist for a single handover controller, the handover controller can reliably identify each of the MIH users and thereby reliably communicate with each of the MIH users.

A second feature of the present invention according to the first feature of the present invention is summarized as that the handover controller notifies the entity which has transmitted the registration request, of the registered entity identifier, and the entity transmits a command to the handover controller, the command including the entity identifier notified from the handover controller.

A third feature of the present invention according to the first feature or the second feature of the present invention is summarized as that each of the entities is a mobility manager (MIH User 109A, for example) configured to manage mobility of the radio communication system from the first radio communication network to the second radio communication network, or a communication application (video streaming client 105, for example) configured to perform communication by using at least one of the first radio communication network and the second radio communication network.

A fourth feature of the present invention according to the third feature of the present invention is summarized as that the mobility manager is an MIH user which is defined in IEEE802.21, and the handover controller is an MIH function which is defined in the IEEE802.21.

A fifth feature of the present invention according to the third feature of the present invention is summarized as that the handover controller is configured to register the entity identifier, while specifying whether the entity is the communication application or not, and calculate a prediction value of future service quality to be used by the entity, on the basis of communication quality of the radio link reported from the link controller, and also notifies the entity of the calculated prediction value.

A sixth feature of the present invention is summarized as a radio communication terminal which performs handover from a first radio communication network to a second radio communication network employing a radio communication method different from that of the first radio communication network, including: a link controller configured to establish a radio link with the first radio communication network or the second radio communication network; a plurality of entities each configured to use at least one of the first radio communication network and the second radio communication network; and a handover controller configured to control handover from the first radio communication network to the second radio communication network on the basis of a request from any one of the entities, wherein each of the entities transmits a registration request which requests registration of the entity, to the handover controller, and the handover controller registers the entity which has transmitted the registration request and an entity identifier which identifies the entity, while associating the entity with the entity identifier, on the basis of the registration request received from the entity.

A seventh feature of the present invention according to the sixth feature of the present invention is summarized as that the handover controller notifies the entity which has transmitted the registration request, of the registered entity identifier, and the entity transmits a command to the handover controller, the command including the entity identifier notified from the handover controller.

An eighth feature of the present invention according to the sixth feature or the seventh feature of the present invention is summarized as that each of the entities is a mobility manager configured to manage mobility of the radio communication system from the first radio communication network to the second radio communication network, or a communication application configured to perform communication by using at least one of the first radio communication network and the second radio communication network.

A ninth feature of the present invention according to the eighth feature of the present invention is summarized as that the mobility manager is an MIH user which is defined in IEEE802.21, and the handover controller is an MIH function which is defined in the IEEE802.21.

A tenth feature of the present invention according to the eighth feature of the present invention is summarized as that the handover controller is configured to register the entity identifier, while specifying whether the entity is the communication application or not, and calculate a prediction value of future service quality to be used by the entity, on the basis of communication quality of the radio link reported from the link controller, and also notifies the entity of the calculated prediction value.

An eleventh feature of the present invention is summarized as a communication controlling method for performing handover from a first radio communication network to a second radio communication network employing a radio communication method different from that of the first radio communication network, comprising the steps of; establishing a radio link with the first radio communication network or the second radio communication network; and controlling handover from the first radio communication network to the second radio communication network on the basis of a request from any one of a plurality of entities each of which uses at least one of the first radio communication network and the second radio communication network, wherein the step of controlling the handover includes the steps of: transmitting a registration request which requests registration of the entity, to a handover controller; and registering the entity which has transmitted the registration request and an entity identifier which identifies the entity, while associating the entity with the entity identifier, on the basis of the registration request received from the entity, and notifying the entity which has transmitted the registration request, of the registered entity identifier.

According to the present invention, provided are a radio communication system, a radio communication terminal and a method for controlling communication which are capable of enabling a handover controller to definitely and reliably perform communication with each mobility managers, even when multiple mobility managers exist for a single handover controller.

### BRIEF DESCRIPTION OF THE DRAWINGS

FIG. 1 is a schematic configuration diagram of an entire communication network according to an embodiment of the present invention.

FIG. 2 is a functional block diagram of a mobile communication terminal 100 according to the embodiment of the present invention.

FIG. 3 is a functional block diagram of a mobile router 200 according to the embodiment of the present invention.

FIG. 4 is a view showing Registration Operation Example 1 of an entity (communication application) of a radio communication system 50 according to the embodiment of the present invention.

FIG. 5 is a view showing Registration Operation Example 1 of the entity (communication application) of the radio communication system 50 according to the embodiment of the present invention.

FIG. 6 is a view showing Registration Operation Example 2 of the entity (communication application) of the radio communication system 50 according to the embodiment of the present invention.

FIG. 7 is a view showing Registration Operation Example 2 of the entity (communication application) of the radio communication system 50 according to the embodiment of the present invention.

FIG. 8 is a view showing a format of MIH_USER_Register.request according to the embodiment of the present invention.

FIG. 9 is a view showing a format of MIH_Get_Service_Quality.request according to the embodiment of the present invention.

FIG. 10 is a view showing a format of MIH_USER_Register.response according to the embodiment of the present invention.

FIG. 11 is a view showing a format of MIH_Get_Service_Quality.response according to the embodiment of the present invention.

FIG. 12 is a view showing a format of MIH_Capability_Discover.request according to the embodiment of the present invention.

FIG. 13 is a view showing a format of MIH_Capability_Discover.confirm according to the embodiment of the present invention.

FIG. 14 is a functional block diagram of a mobile communication terminal 100A according to a modification of the present invention.

### MODES FOR CARRYING OUT THE INVENTION

Next, an embodiment of the present invention will be described. Specifically, descriptions will be given of (1) a schematic configuration of an entire communication network, (2) a functional block configuration of a radio communication system, (3) operations of the radio communication system, (4) advantages and effects, and (5) alternative embodiments.

Note that, throughout the following descriptions of the drawings, the same or similar parts bear the same or similar reference numerals. It should be noted, however, that the drawings are schematic, and that the dimensional proportions and the like are different from their actual values.

Accordingly, specific dimensions and the like should be inferred based on the descriptions given below. Moreover, dimensional relationships and dimensional proportions may differ from one drawing to another in some parts.

### (1) Schematic Configuration of Entire Communication Network

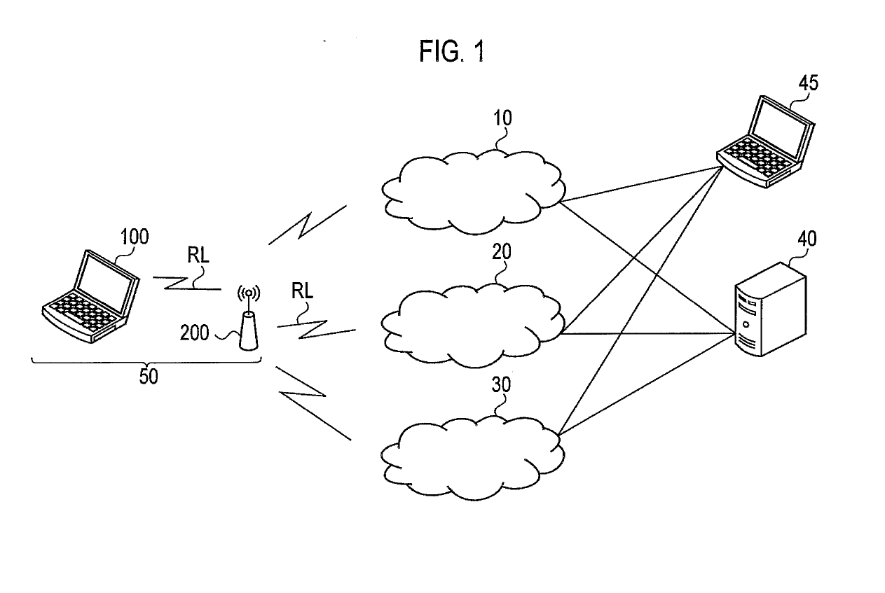

FIG. 1 is a schematic configuration diagram of an entire communication network according to this embodiment. The communication network according to this embodiment includes a radio communication network 10, a radio communication network 20 and a radio communication network 30. The radio communication network 10 is based on CDMA2000 1xEV-DO. In this embodiment, the radio communication network 10 serves as a first radio communication network. The radio communication network 20 is based on MBWA (iBurst (registered trademark)) standardized under IEEE802.20. In this embodiment, the radio communication network 20 serves as a second radio communication network. The radio communication network 30 is based on mobile WiMAX standardized under IEEE802.16e. Accordingly, the radio communication networks 10 to 30 employ different radio communication methods (media), respectively.

Wired connection is established between each of the radio communication networks 10 to 30 and each of a video streaming server 40 and a CN 45 (Corresponding Node). In addition, radio connection is established between each of the radio communication networks 10 to 30 and a mobile router 200.

The mobile router 200 establishes a radio link RL with each of the radio communication networks 10 to 30 and a mobile communication terminal 100.

The video streaming server 40 and the CN 45 run communication applications with the mobile communication terminal 100. The video streaming server 40 runs a video streaming application on the basis of a request from the mobile communication terminal 100, and then broadcasts streaming data to the mobile communication terminal 100. The CN 45 and the mobile communication terminal 100 run a TV phone application using VoIP or the like, thereby providing TV phone service between the CN 45 and the mobile communication terminal 100.

The mobile communication terminal 100 and the mobile router 200 are mobile. The mobile communication terminal 100 is carried by a user or the like of the mobile communication terminal 100. The mobile router 200 is installed in a mobile space such as a railroad vehicle. In this embodiment, the mobile communication terminal 100 and the mobile router 200 establish a radio communication system 50.

The radio communication system 50 implements Media Independent Handover Function (MIHF) defined in IEEE802.21, in order to perform seamless handover between the radio communication networks 10 to 30 employing the different radio communication methods (media). In addition, the video streaming server 40 is also capable of implementing MIHF.

### (2) Functional Block Configuration of Radio Communication System

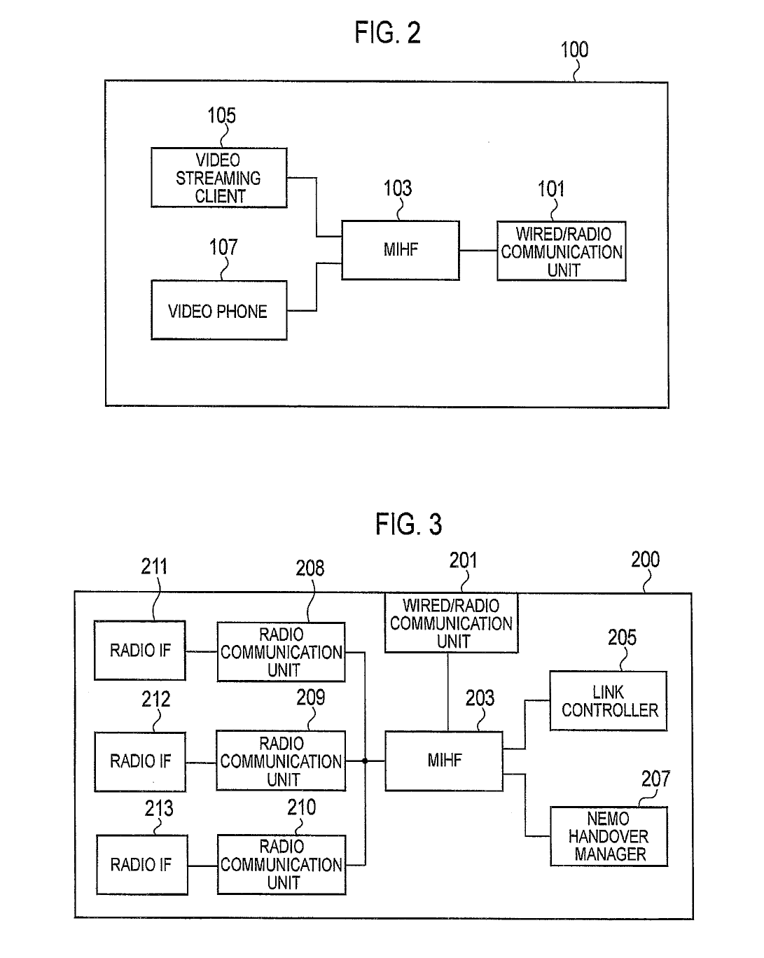

Next, descriptions will be given of functional block configurations of the mobile communication terminal 100 and the mobile router 200 establishing the radio communication system 50. FIG. 2 is a functional block diagram of the mobile communication terminal 100. FIG. 3 is a functional block diagram of the mobile router 200.

### (2.1) MOBILE COMMUNICATION TERMINAL 100

As shown in FIG. 2, the mobile communication terminal 100 includes a wired/radio communication unit 101, an MIH function 103 (MIHF 103, below), a video streaming client 105 and a video phone 107.

The wired/radio communication unit 101 is configured to perform wired or radio communication with a wired/radio communication unit 201 of the mobile router 200. As a radio communication method between the mobile communication terminal 100 and the mobile router 200, WLAN standardized under IEEE802.21 may be used, for example.

The MIHF 103 is configured to control handover between radio communication networks on the basis of a request from any of the entities, specifically, any one of the video streaming client 105 and the video phone 107, which are configured to function as upper layers of the MIHF 103. The MIHF 103 is configured to assist in adaptively controlling parameters in accordance with communication qualities of the radio links RL between the mobile router 200 and the radio communication networks 10 to 30. In this embodiment, the MIHF 103 serves as a handover controller.

The MIHF 103 is MIHF function (MIHF) defined in IEEE802.21. In other words, the MIHF 103 is a set of multiple essential functions necessary for handover between radio communication networks employing different radio communication methods (heterogeneous media). Moreover, the MIHF 103 is configured to organically link an upper protocol stack of the layer 3 to a protocol of the layer 1/layer 2 across layers. The MIHF 103 is configured, for example, to relay various commands and events between communication applications of the video streaming client 105, the video phone 107 and the like and a link controller 205 (see FIG. 3) included in the mobile router 200 in this example, the commands being related to handover, and transmitted from the communication applications and relayed to the link controller 205, the events being each transmitted from the link controller 205and relayed to a corresponding one of the communication applications.

The video streaming client 105 and the video phone 107 are configured to perform communication by using any one of or some of the radio communication networks 10 to 30. In other words, the video streaming client 105 and the video phone 107 use at least one of the radio communication networks 10 to 30.

The video streaming client 105 is configured to perform processing for receiving video streaming data broadcasted from the video streaming server 40. The video phone 107 is configured to run a TV phone application using VoIP or the like, with the CN 45, thereby providing voice call service.

The video streaming client 105 and the video phone 107 (referred to as communication applications in short below when appropriate) are each configured to transmit a command to an MIH function 203 (see FIG. 3) of the mobile router 200, the command including a registration request to request registration of the communication application. Specifically, the communication application transmits MIH_USER_Register.request to the MIH function 203.

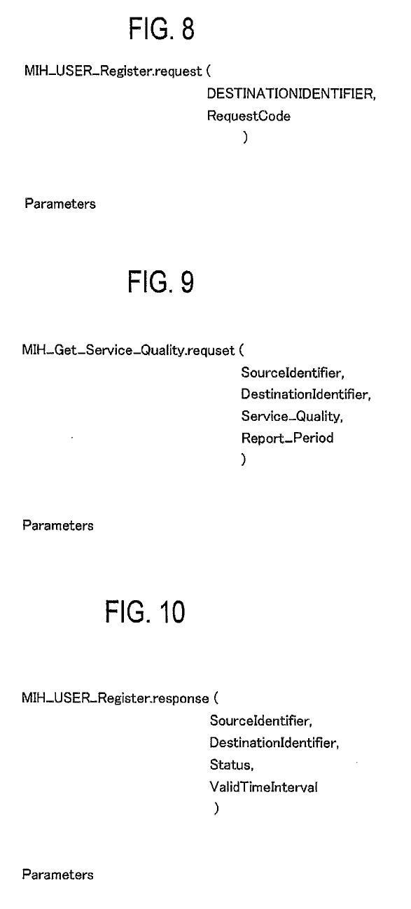

FIG. 8 shows a format of MIH_USER_Register.request. Further, Table 1 and Table 2 show the contents of parameters included in MIH_USER_Register.request.

TABLE 1

| Name | Data Type | Description |
|---|---|---|
| SourceIdentifier | MIH_User_ID | This identifies |
| | | MIH_USER that will |
| | | be the source of this |
| | | request. |
| DestinationIdentifier | MIHF_ID | This identifies local or |
| | | remote MIHF that will |
| | | be the destination of |
| | | this request. |
| RequestCode | REG_REQUEST_CODE | Registration request |
| | | code |

TABLE 2

| Data Type name | Derived from | Definition |
|---|---|---|
| REG_REQUEST_CODE | ENUMRATED | The Registration Code |
| | | 0: Register as Non |
| | | Application |
| | | 1: Register as Application |
| | | with Related Available |
| | | BandwidthNotification |
| | | 0: Re-register as Non |
| | | Application |
| | | 1: Re-register as |
| | | Application |

In this embodiment, each communication application corresponds to MIH user defined in IEEE802.21. AS shown in Table 1, MIH_USER_Register.request includes source and destination identifiers (SourceIdentifier, DestinationIdentifier) and registration request code (RequestCode). In addition, as shown in Table 2, non communication-application (value=0) or communication application (value=1) are used as the type of the registration request code.

If MIH_USER_ID included in MIH_USER_Register.reponse corresponding to MIH_USER_Register.request is notified from the MIHF 103, the communication application thereafter transmits a command including notified MIH_USER_ID when needed, to the MIHF 103 and the MIHF 203.

Moreover, the communication application transmits MIH_Get_Service_Quality.request (service quality acquisition request) to the MIH function 203 of the mobile router 200, the request requesting to be reported, every certain period (100 ms, for example), about the quality of service used by the communication application.

FIG. 9 shows a format of MIH_Get_Service_Quality.request. Further, Table 3 and Table 4 show the contents of parameters included in MIH_Get_Service_Quality.request.

TABLE 3

| Name | Data Type | Description |
|---|---|---|
| SourceIdentifier | MIH_User_ID | This identifies |
| | | MIH_USER that will be |
| | | the source of this request. |
| DestinationIdentifier | MIHF_ID | This identifies local or |
| | | remote MIHF that will |
| | | be the destination of this |
| | | request. |
| Service_Quality1 | Service_Quality_REQ1 | Predicted Service |
| | | Quality1 |
| Service_Quality2 | Service_Quality_REQ2 | Predicted Service |
| | | Quality2 |
| Report_Period | INTEGER | Period to be reported |
| | | (ms unit) |

TABLE 4

| Data Type name | Derived from | Definition |
|---|---|---|
| Service_Quality_REQ1 | UNSIGNED_INT(1) | Predicted Available |
| | | Band Width request |
| | | from now to next |
| | | report. |
| Service_Quality_REQ2 | UNSIGNED_INT(1) | Predicted delay for |
| | | Uplink and Downlink |

As shown in Table 3, MIH_Get_Service_Quality.request includes source and destination identifiers (SourceIdentifier, DestinationIdentifier), request service qualities (Service_Quality1, Service_Quality2) and report period (Report_Period). Moreover, as shown in Table 4, predicted available band width (uplink and downlink) or predicted delay (uplink and downlink) is used as the type of the request service quality.

### (2.2) MOBILE ROUTER 200

As shown in FIG. 3, the mobile router 200 includes a wired/radio communication unit 201, an MIH function 203 (MIHF 203, below), a link controller 205, an NEMO handover manager 207, radio communication units 208 to 210 and radio IFs 211 to 213.

The wired/radio communication unit 201 is configured to perform wired or radio communication with the wired/radio communication unit 101 of the mobile communication terminal 100.

The MIHF 203, as the MIHF 103, is configured to control handover between radio communication networks on the basis of a request from any one of the video streaming client 105 and the video phone 107, which are configured to function as upper layers of the MIHF 203. In addition, the MIHF 203 is configured to assist in adaptively controlling parameters in accordance with communication qualities of the radio links RL between the mobile router 200 and the radio communication networks 10 to 30. In this embodiment, the MIHF 203 serves as a handover controller. The MIHF 203 is MIH function (MIHF) defined in IEEE802.21.

On the basis of MIH_USER_Register.request received from the video streaming client 105 or the video phone 107, the MIHF 203 registers the video streaming client 105 or the video phone 107, i.e., the entity, which has transmitted MIH_USER_Register.request, and MIH_USER_ID (entity identifier) which identifies the entity, while associating the entity with MIH_USER_ID. The MIHF 203 is capable of registering MIH_USER ID while specifying whether the entity is a communication application or not, on the basis of the register request code (RequestCode) included in received MIH_USER_Register.request.

The MIHF 203 notifies the entity which has transmitted MIH_USER_Register.request, of MIH_USER_Register.response including registered MIH_USER_ID. Specifically, the MIHF 203 notifies the entity which has transmitted MIH_USER_Register.request, of MIH_USER_Register.response which is an event including MIH_USER_ID.

FIG. 10 shows a format of MIH_USER_Register.response. Further, Table 5 shows the contents of parameters included in MIH_USER_Register.response.

TABLE 5

| Name | Data Type | Description |
|---|---|---|
| SourceIdentifier | MIHF | This identifies local or remote |
| | | MIHF that will be the source |
| | | of this request |
| DestinationIdentifier | MIHF_ID and | This identifies local or remote |
| | MIH_USER_ID | MIHF, and MIH_USER that |
| | | will be the destination of this |
| | | request MIH_USER_ID is |
| | | assigned. |
| Status | STATUS | Status of Operation. |
| ValidTimeInterval | Unsigned_INT(4) | Time Interval in seconds |
| | | during which the registration |
| | | is valid. |

As shown in Table 5, MIH_USER_Register.response includes source and destination identifiers (Sourceldentifier, Destinationldentifier), operation status (Status) and registration valid time interval (ValidTimelnterval). Destinationldentifier includes MIH_USER_ID.

Moreover, the MIHF 203 acquires service quality acquisition request (MIH_Get_Service_Quality.request) which requests to be reported, every certain period, about the quality of service (QoS) used by the communication application, from the communication application. Acquiring the service quality acquisition request, the MIHF 203 calculates a prediction value of the future service quality every certain period, on the basis of the communication qualities of the radio links RL reported from the link controller 205.

Specifically, the MIHF 203 acquires DRC (Data Rate Control) value of each radio link RL. The DRC value is the class of a transmission rate (modulation method) determined on the basis of receiving SINR of the radio link RL established between the mobile router 200 and each of the radio communication networks 10 to 30. The MIHF 203 generates a table which associates each acquired DRC with the actual transmission rate (throughput).

Subsequently, the MIHF 203 counts the number of slots allocated to data transmission of the communication application in a predetermined time period (T1) (allocated slot number), and then calculates a slot allocation rate on the basis of the allocated slot number in relation to the total number of slots in T1. Further, the MIHF 203 calculates the maximum value (or the average value) of the slot allocation rates in a past predetermined time period (T2). Here, T2 is usually set longer than T1 as in the case of setting T2=5T1, for example.

The MIHF 203 multiplies the transmission rate associated with the current DRC and the maximum value (or the average value) of the slot allocation rate together. The MIHF 203 uses the multiplication result as a prediction value of the service quality (transmission rate).

The MIHF 203 notifies the communication application which has transmitted the service quality acquisition request, of the obtained prediction value by means of MIH_Get_Service_Quality.response.

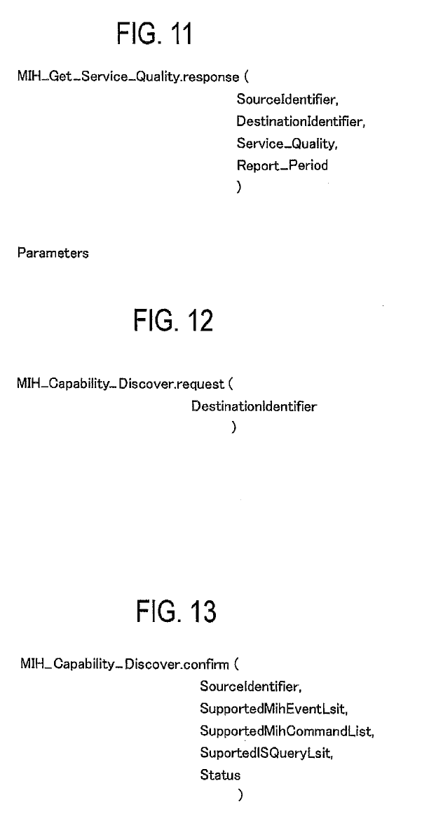

FIG. 11 shows a format of MIH_Get_Service_Quality.response. Further, Table 6 and Table 7 show the contents of parameters included in MIH_Get_Service_Quality.response.

TABLE 6

| Name | Data Type | Description |
|---|---|---|
| SourceIdentifier | MIHF_ID | This identifies local or |
| | | remote MIHF that |
| | | will be the source of |
| | | this request. |
| DestinationIdentifier | MIH_USER | This identifies |
| | | MIH_USER that will |
| | | be the destination of |
| | | this request. |
| Service_Quality1 | Service_Quality_Value1 | Predicted Service |
| | | Quality1 |
| Service_Quality2 | Service_Quality_Value2 | Predicted Service |
| | | Quality2 |
| Report_Period | INTEGER | Period to be reported |
| | | (ms unit) |

TABLE 7

| Data Type name | Derived from | Definition |
|---|---|---|
| Service_Quality_Value1 | UNSIGNED_INT(1) | Predicted Available |
| | | Band Width value |
| | | in kbps unit from |
| | | now to next report. |
| Service_Quality_Value2 | UNSIGNED_INT(1) | Predicted delay for |
| | | Uplink and |
| | | Downlink. |

As shown in Table 6, MIH_Get_Service_Quality.response includes source and destination identifiers (SourceIdentifier, DestinationIdentifier), predicted service qualities (Service_Quality1 , Service_Quality2) and report period (Report_Period). Moreover, as shown in Table 7, predicted available band width (uplink and downlink) or predicted delay (uplink and downlink) is used as the type of the predicted service quality.

FIG. 12 shows a format of MIH_Capability_Discover.request. Further, Table 8 shows the contents of parameters included in MIH_Capability_Discover.request.

TABLE 8

| Name | Type | Valid range | Description |
|---|---|---|---|
| Destination | Identifier | Valid MIHF | The description Identifier of |
| Identifier | | identifier | request or response. This is the |
| | | | identifier of local or peer MIHF. |

As shown in Table 8, MIH_Capability_Discover.request includes destination identifier (Destinationldentifier).

FIG. 13 shows a format of MIH_Capability_Discover.confirm. Further, Table 9 shows the contents of parameters included in MIH_Capability_Discover.confirm.

TABLE 9

| Name | Type | Valid range | Description |
|---|---|---|---|
| Source | Identifier | Valid MIHF | This the MIHF ID of local or peer MIHF entity |
| Identifier | | identifier | that this primitive is originated. |
| Supported | List | Set of supported | List of supported events on MIHF. The encoding |
| MIH Event List | | events | uses a bitmap where the bit position represents |
| | | | the MIHF Event ID as defined in Table 25. A bit |
| | | | set to 1 indicates that event is supported. |
| Supported MIH | Bitmap | N/A | List of supported commands on MIHF. The |
| Command List | | | encoding uses the following bitmap where a bit |
| | | | set to 1 indicates that commands is supported. |
| | | | Bit 0: MIH_Get_Status |
| | | | Bit 1: MIH_Switch |
| | | | Bit 2: MIH_Configure_Link |
| | | | Bit 3: MIH_Scan |
| | | | Bit 4: MIH_Net_HO_Candidate_Query |
| | | | MIH_Net_HO_Candidate_Commit |
| | | | MIH_N2N_HO_Query_Resources |
| | | | MIH_N2N_HO_Complete |
| | | | Bit 5: MIH_MN_HO_Candidate_Query |
| | | | MIH_MN_HO_Cnadidate_Commit |
| | | | MIH_MN_HO_Complete |
| | | | Bit 6: MIH_Network_Address_Information |
| | | | Bit 7: Notification of Predicted Available |
| | | | Bandwidth (Uplink/Downlink) |
| | | | Bit 8: Notification of Predicted Delay |
| | | | (Uplink/Downlink) |
| | | | Bit 9-31: Reserved |
| Supported IS | List | Set of supported | List of supported MIIS query types |
| Query Type List | | MIIS query types | |
| Status | Enumerated | Success | Status of operation |
| | | Error | |

As shown in Table 9, MIH_Capability_Discover.confirm includes source identifier (SourceIdentifier), lists of supported MIH events, commands and the like (Supported MIH Event List, Supported MIH Command List, Supported IS Query Type List) and status.

Table 10 shows identifiers of MIH events.

TABLE 10

| MIH event name | ID |
|---|---|
| MIH_Link_Up | 0 |
| MIH_Link_Down | 1 |
| MIH_Link_Going_Down | 2 |
| MIH_Link_Event_Rollback | 3 |
| MIH_Link_Detected | 4 |
| MIH_Link_Parameters_Report | 5 |
| MIH_Link_PDU_Transmit_Status | 6 |
| MIH_Link_Handover_Imminent | 7 |
| MIH_Link_Handover_Complete | 8 |
| Notification of Predicted Available Bandwidth (Uplink/Downlink) | 9 |
| Notification of Predicted Delay (Uplink/Downlink) | 10 |
| Reserved | 11-31 |

In this embodiment, predicted available band width and predicted delay (uplink/downlink) are notified from using bits 7 and 8 of the Supported MIH Command List, respectively (see Table 9). In addition, IDs 9 and 10 are allocated to the predicted available band width and predicted delay, respectively (see Table 10).

The link controller 205is configured to control the radio communication units 208 to 210 in accordance with an instruction from the MIHF 203, and to establish a radio link RL through each of the radio IFs 211 to 213 corresponding respectively to the radio communication networks 10 to 30. Specifically, the link controller 205 performs an interface (device driver) function for the radio communication units 208 to 210, and establishes a radio link RL corresponding to the radio communication method employed by each of the radio communication networks. Further, the link controller 205 is configured to acquire information indicating communication qualities of the radio links RL established for the radio communication networks, from the radio communication units 208 to 210.

The NEMO handover manager 207 is configured to manage mobility of the mobile router 200 (and the mobile communication terminal 100). Specifically, the NEMO handover manager 207 performs processing necessary for securing IP mobility of the mobile router 200, in accordance with Network Mobility (NEMO) Basic Support Protocol (RFC 3963).

The radio communication units 208 to 210 respectively include modules corresponding to the radio communication networks 10 to 30, and are configured to perform radio communication through the radio IFs 211 to 213 corresponding respectively to the radio communication networks 10 to 30, in accordance with an instruction from the link controller 205.

### (3) Operations of Radio Communication System

Next, descriptions will be given of operations of the above-described radio communication system 50 (the mobile communication terminal 100 and the mobile router 200).

### (3.1) OPERATION EXAMPLE 1

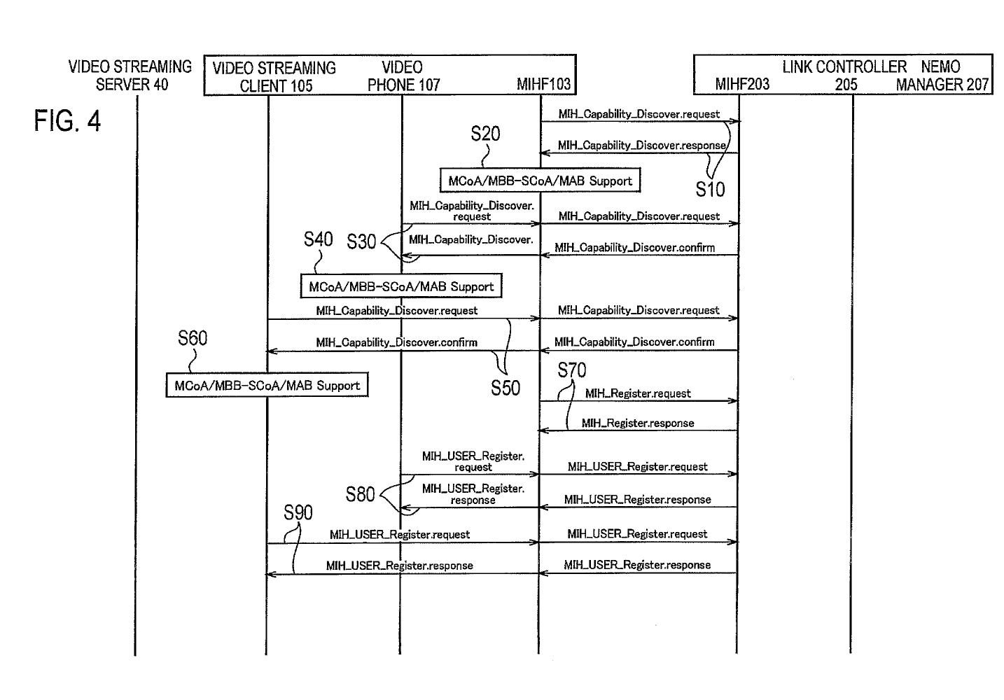

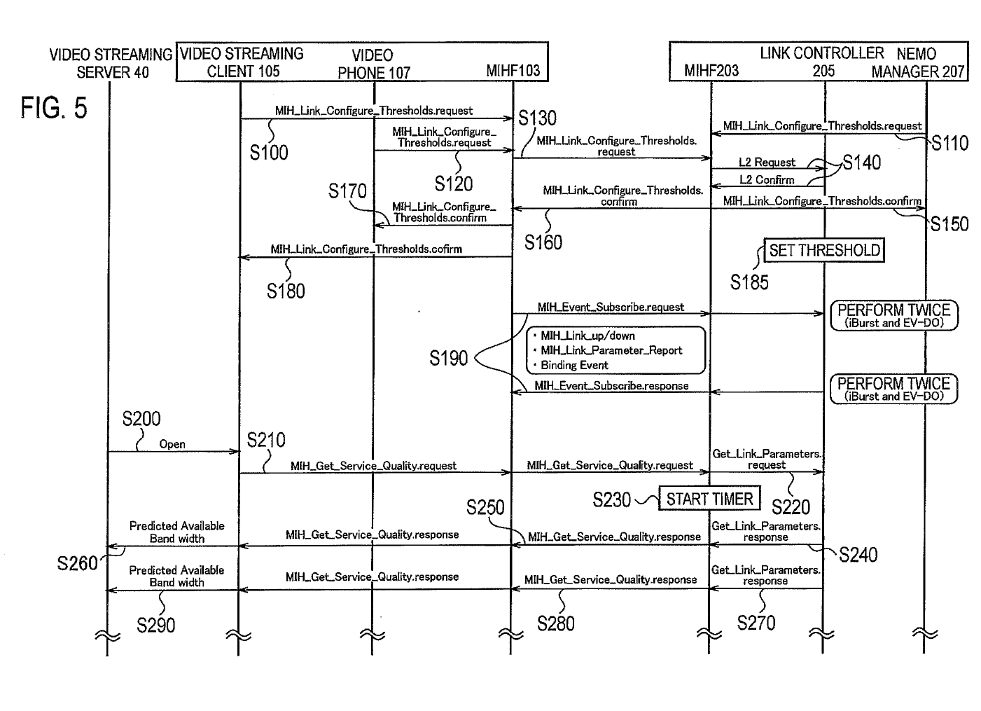

FIG. 4 and FIG. 5 show Registration Operation Example 1 of entities (communication applications) of the radio communication system 50.

As shown in FIG. 4, in Step S10, the MIHF 103 transmits MIH_Capability_Discover.request to the MIHF 203 to inquire of the MIHF 103 about whether or not there exists any radio communication network (radio link RL) with which handover between radio communication networks employing different radio communication methods (heterogeneous media) can be performed. On the basis of the inquiry, the MIHF 203 transmits MIH_Capability_Discover.confirm to the MIHF 103 to notify the MIHF 103 of a radio communication network with which media independent handover can be performed.

In other words, the MIHF 103 discovers an MIHF to be paired (here, the MIHF 203) by broadcasting the MIH_Capability_Discover.request. Thereby, the MIHF 103 can identify information on the types of communication networks and handover from the MIHF to be paired and the address of the MIHF to be paired, from a layer-2 data frame. In addition, the MIHF 103 can notice that the MIHF to be paired has service quality prediction notification function.

In Step S20, the MIHF 103 performs preparation for media independent handover (MIH) on the basis of the result notified from the MIHF 203. Specifically, the MIHF 103 performs preparation for lossless handover which uses Multiple Care of Address (MCoA) (Make Before Break) or handover which uses Single Care of Address (SCoA) (Make After Break or Make Before Break).

In Step S30, the video phone 107, which functions as an upper layer of the MIHF 103, transmits MIH_Capability_Discover.request to the MIHF 103 and the MIHF 203. The MIHF 203 transmits MIH_Capability_Discover.confirm to the video phone 107 through the MIHF 103.

In Step S40, the video phone 107 performs preparation for media independent handover (MIH) on the basis of the result notified from the MIHF 203. In addition, the video phone 107 notices that the MIHF 103 and the MIHF 203 have service quality prediction notification function.

In Step S50, the video streaming client 105 transmits MIH_Capability_Discover.request to the MIHF 103. The MIHF 103 transmits received MIH_Capability_Discover.request to the MIHF 203.

On the basis of the received MIH_Capability_Discover.request, the MIHF 203 transmits MIH_Capability_Discover.confirm to the MIHF 103, and the MIHF 103 then transmits received MIH_Capability_Discover.confirm to the video streaming client 105.

In Step S60, the video streaming client 105 performs preparation for media independent handover (MIH) on the basis of the result notified from the MIHF 203. In addition, the video streaming client 105 notices that the MIHF 103 and the MIHF 203 have service quality prediction function.

In Step S70, the MIHF 103 transmits MIH_Register.request to the MIHF 203 to request registration of the MIH. On the basis of received MIH_Register.request, the MIHF 203 transmits MIH_Register.response indicating that the MIHF 103 is registered, to the video streaming client 105. Note that MIH_Register.request and MIH_Register.response are not defined in IEEE802.21, but are newly defined.

In Step S80, the video phone 107 transmits MIH_USER_Register.request to the MIHF 203 through the MIHF 103 to request registration of the video phone 107 to the MIHF 203. On the basis of received MIH_USER_Register.request, the MIHF 203 registers the video phone 107 which has transmitted MIH_USER_Register.request, and MIH_USER_ID which identifies the video phone 107, while associating the video phone 107 with MIH_USER_ID. The MIHF 203 notifies the video phone 107 which has transmitted MIH_USER_Register.request, of MIH_USER_Register.response including MIH_USER_ID.

In Step S90, the video streaming client 105 transmits MIH_USER_Register.request to the MIHF 203 through the MIHF 103 to request registration of the video streaming client 105 to the MIHF 203. On the basis of received MIH_USER_Register.request, the MIHF 203 registers the video streaming client 105 which has transmitted MIH_USER_Register.request, and MIH_USER_ID which identifies the video streaming client 105, while associating the video streaming client 105 with MIH_USER_ID. The MIHF 203 notifies the video streaming client 105 which has transmitted MIH_USER_Register.request, of MIH_USER_Register.response including MIH_USER_ID.

Subsequently, as shown in FIG. 5, in Step S100, the video streaming client 105 notifies the MIHF 103 of the threshold of the quality of service used by the video streaming client 105 (MIH_Link_Configure_Threshold.request). Then, in Step S110, the NEMO handover manager 207 notifies the MIHF 203 of the threshold of the quality of service of the mobile router 200 (MIH_Link_Configure_Threshold.request). Moreover, in Step S120, the video phone 107 notifies the MIHF 103 of the threshold of the quality of service used by the video phone 107 (MIH_Link_Configure_Threshold.request).

Acquiring MIH_USER_ID included in MIH_USER_Register.response, the video streaming client 105 and the video phone 107 can thereafter transmit MIH_Link_Configure_Threshold.request and other commands including MIH_USER_ID, to the MIHF 103.

In Step S130, the MIHF 103 notifies the MIHF 203 of the threshold of the service quality (MIH_Link_Configure_Threshold.request) determined on the basis of the thresholds of the service qualities notified from the video streaming client 105 and the video phone 107.

In Step S140, the MIHF 203 requests to establish a logical link in the layer 2, and the link controller 205 transmits confirmation of the request to the MIHF 203 in response.

In Step S150, as a response to the MIH_Link_Configure_Threshold.request from the NEMO handover manager 207, the MIHF 203 transmits MIH_Link_Configure_Threshold.confirm to the NEMO handover manager 207. Then, in Step S160, as a response to the MIH_Link_Configure_Threshold.request from the MIHF 103, the MIHF 203 transmits MIH_Link_Configure_Threshold.confirm to the MIHF 103.

In Step S170, on the basis of MIH_Link_Configure_Threshold.confirm received from the MIHF 203, the MIHF 103 transmits MIH_Link_Configure_Threshold.confirm including the threshold of the service quality set for the MIHF 103 and the MIHF 203, to the video phone 107. Similarly, in Step S180, on the basis of MIH_Link_Configure_Threshold.confirm received from the MIHF 203, the MIHF 103 transmits MIH_Link_Configure_Threshold.confirm including the threshold of the service quality set for the MIHF 103 and the MIHF 203, to the video streaming client 105.

In Step S185, on the basis of the logical link establishment request from the MIHF 203, the link controller 205 sets the thresholds of the service of qualities of currently-connected radio communication networks and radio communication networks to be handover candidates.

In Step S190, the MIHF 103 transmits MIH_Event_Subscribe.Request to the MIHF 203 and the link controller 205 to request to be notified of events related to the MIH. The events include MIH_Link_up/down, MIH_Link_Parameters_Report, Binding Event and the like. This process is performed the number of times corresponding to that of the currently-connected radio communication networks and the radio communication networks to be handover candidates. In this embodiment, the radio communication network 10 (1xEV-DO) and the radio communication network 20 (iBurst (registered trademark)) are considered as these radio communication networks.

In Step S200, as a response to MIH_Event_Subscribe.Request, the link controller 205 transmits MIH_Event_Subscribe.response to the MIHF 103 and the MIHF 203. Here, this process is also performed the number of times corresponding to that of the currently-connected radio communication networks and the radio communication networks to be handover candidates.

In Step S200, starting communicating with the video streaming client 105, the video streaming server 40 requests to be notified of the current transmission rate (band width or throughput) in the downlink.

In Step S210, the video streaming client 105 transmits MIH_Get_Service_Quality.request to the MIHF 203 through the MIHF 103 to request to be reported, every certain period, the quality of service used by the video streaming client 105. Here, the format of MIH_Get_Service_Quality.response is as shown in Table 1 and Table 2.

In Step S220, the MIHF 203 transmits Get_Link_Parameters.request to the link controller 205 to request to be notified of link parameters of the currently-connected radio communication networks. Then, in Step S230, the MIHF 203 starts a timer for timing the period (certain period) for reporting the service quality. In other words, the MIHF 203 starts the timer for noticing the timings for transmitting Get_Link_Parameters.request and MIH_Get_Service_Quality.response Note that the period for reporting the quality of service (100 ms, for example) may be changed appropriately depending on the throughputs or the like of the mobile communication terminal 100 and the mobile router 200.

In Step S240, the link controller 205 transmits Get_Link_Parameters.response to the MIHF 203 to notify the MIHF 203 of link parameters of the currently-connected radio communication networks. In Step S250, on the basis of the link parameters transmitted from the link controller 205 and including DRC, SINR and the like, the MIHF 203 transmits MIH_Get_Service_Quality.response to the video streaming client 105 through the MIHF 103 to report the current service quality (transmission rate).

In Step S260, the video streaming client 105 reports the service quality (predicted available band width (uplink/downlink) or throughput) included in MIH_Get_Service_Quality.response received from the MIHF 203, to the video streaming client 105.

Thereafter, the above-described process in Steps S240 to S260 is repeated in Steps S270 to S290 at regular intervals. In addition, the MIHF 103, the MIHF 203 and the link controller 205 perform the same process for the video phone 107 as well.

### (3.2) OPERATION EXAMPLE 2

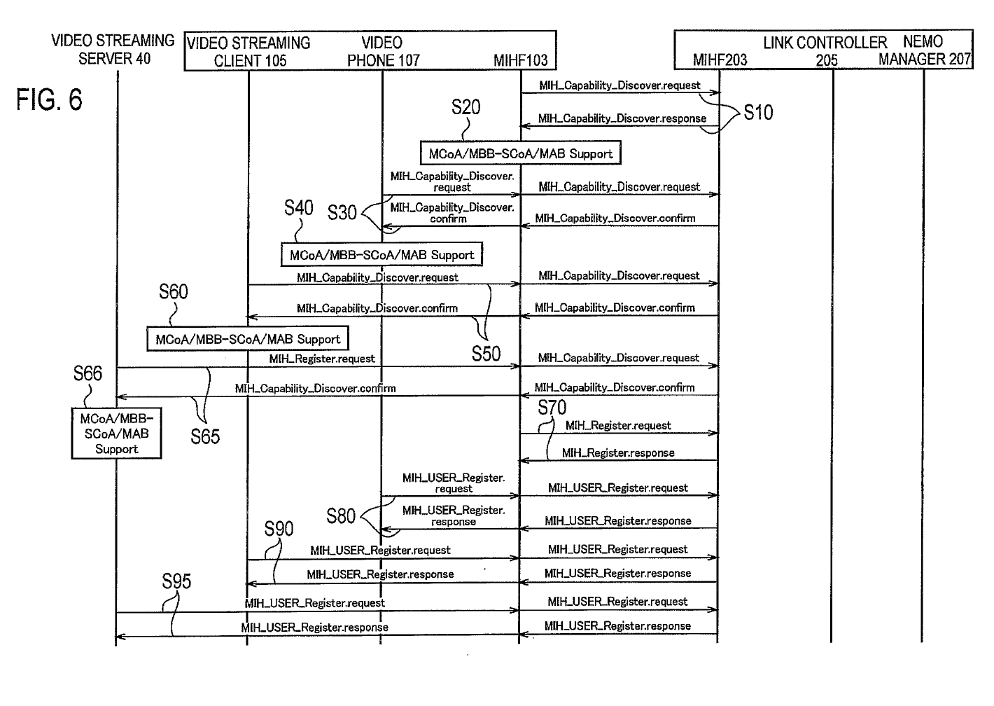

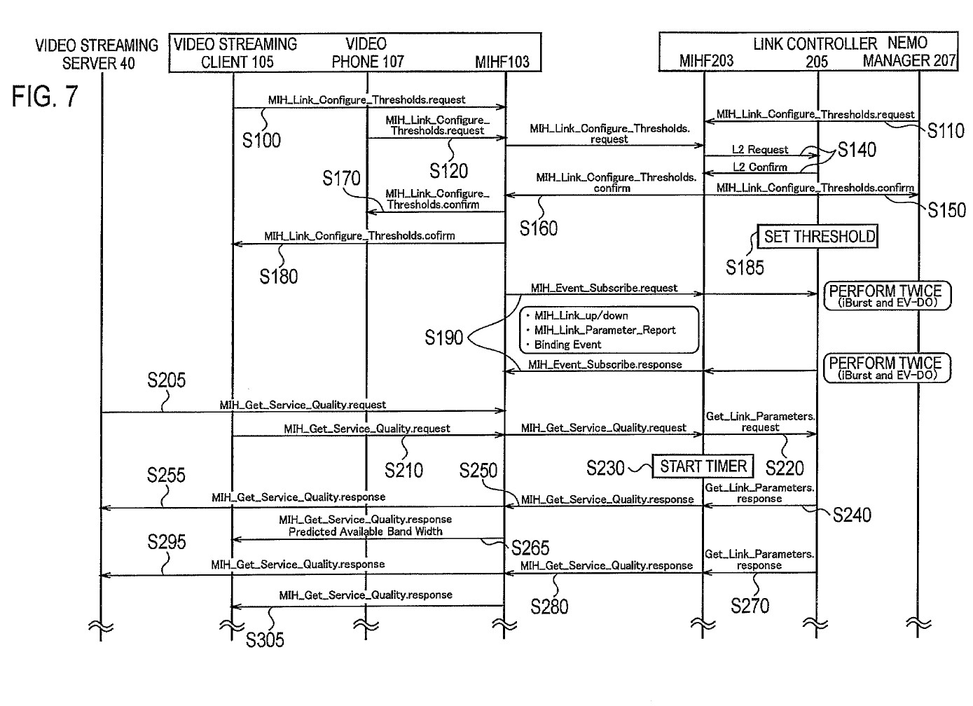

FIG. 6 and FIG. 7 show Registration Operation Example 2 of the entities (communication applications) of the radio communication system 50. In this example, the difference, compared to Operation Example 1 described above, is that the video streaming server 40 also includes an MIHF.

The process in Steps S10 to S60 is the same as that of Operation Example 1 shown in FIG. 4. In Step S65, the video streaming server 40 transmits MIH_Register.request to the MIHF 103 to request to register MIH. On the basis of received MIH_Register.request, the MIHF 103 transmits MIH_Capability_Discover.request to the MIHF 203.

On the basis of received MIH_Capability_Discover.request, the MIHF 203 transmits MIH_Capability_Discover.confirm to the MIHF 103. Then, the MIHF 103 transmits received MIH_Capability_Discover.confirm to the video streaming server 40.

In Step S66, on the basis of the result notified from the MIHF 203, the video streaming server 40 performs preparation for media independent handover (MIH).

The process in Steps S70 to S90 is the same as that of Operation Example 1 shown in FIG. 4. In Step S95, the video streaming server 40 transmits MIH_USER_Register.request to the MIHF 203 through the MIHF 103 to request to register the video streaming server 40 to the MIHF 203. On the basis of received MIH_USER_Register.request, the MIHF 203 registers the video streaming server 40 which has transmitted MIH_USER_Register.request, and MIH_USER_ID which identifies the video streaming server 40, while associating the video streaming server 40 with MIH_USER_ID. The MIHF 203 notifies the video streaming server 40 which has transmitted MIH_USER_Register.request, of MIH_USER_Register.response including MIH_USER_ID.

The process in Step S100 to S190 is the same as that of Operation Example 1 shown in FIG. 5. As shown in FIG. 7, in Step S205, the video streaming server 40 transmits, as the video streaming client 105 and the like, MIH_Get_Service_Quality.request to the MIHF 203 through the MIHF 103 to request to be reported, every certain period, the quality of service used by the video streaming server 40.

The process in Steps S210 to S250 is the same as that of Operation Example 1 shown in FIG. 5. In Step S255, the MIHF 103 relays MIH_Get_Service_Quality.response received from the MIHF 203, to the video streaming server 40. Then, in Step S265, the MIHF 103 relays MIH_Get_Service_Quality.response received from the MIHF 203, to the video streaming client 105.

Thereafter, the process in Steps S240 to S265 described above is repeated in Steps S270 to S305 at regular intervals.

Here, the significances of including an MIHF in the video streaming server 40 are as follows: (1) even a mobile communication terminal with an ordinary video streaming client not having the adaptive control function can acquire a predicted available band width and information on handover, if the video streaming server 40 directly communicates with an MIHF of the mobile communication terminal, which enables controlling parameters such as a transmission rate adaptively in accordance with change in communication quality in a radio section; and (2) by taking into of video streaming service, in which the video streaming server 40 performs control adaptive to change in communication quality in a radio section in a top-down manner, the video streaming server 40 can perform adaptive control appropriate for the throughput of the server by finding out how often clients (mobile communication terminals) have the adaptive control function. For example, the report period for predicted available band width can be changed in accordance with the number of clients, and the type of downlink transmission rate can be changed in accordance with the number of clients.

### (4) Effects and Advantages

By employing the radio communication system 50, receiving MIH_USER_Register.request from a certain entity such as a communication application (the video streaming client 105 or the video phone 107), the MIHF 103 and the MIHF 203 register the entity and MIH_USER_ID which identifies the entity, while associating the entity with MIH_USER_ID.

Accordingly, even when the entities such as communication applications each function as an MIH user and hence multiple MIH users exist for the MIHF 103 and the MIHF 203, the MIHF 103 and the MIHF 203 can reliably identify each of the MIH users and thereby reliably communicate with each of the MIH users.

In this embodiment, each communication application can transmit a command including MIH_USER_ID notified from the MIHF 103 or the MIHF 203, to the corresponding one of the MIHF 103 and the MIHF 203. This makes it possible for the MIHF 103 and the MIHF 203 to quickly find out the communication application which has generated a command, by checking MIH_USER_ID included in the command. As a result, processing speed for the command is increased.

In this embodiment, the MIHF 103 and the MIHF 203 can register MIH_USER_ID, while specifying whether an entity which has requested the registration is a communication application or not. In addition, the MIHF 103 and the MIHF 203 can calculate a prediction value of future service used by the entity, on the basis of the communication quality of a radio link notified from the link controller 205. Furthermore, the MIHF 103 and the MIHF 203 can notify the entity of the obtained prediction value.

Accordingly, the MIHF 103 and the MIHF 203 can notice service quality acquisition requests from all the entities including communication applications and find out service qualities thereof, and can thereby determine transmission rates to be set for the entities, by taking account of the service qualities of the entities. Especially when multiple communication applications exist, efficient control of the service qualities such as transmission rates (band widths) and delays for the communication applications can be performed. In other words, finding out a value of future service quality on the basis of the prediction value, each communication application can easily maintain service quality relevant for the condition (encoding rate, for example) of the communication application by adaptively controlling the condition on the basis of the value.

### (5) Alternative Embodiments

The essence of the present invention has been disclosed by using an embodiment of the present invention as described above. However, the descriptions and drawings forming part of this disclosure should not be considered to limit the present invention. Various alternative embodiments can be apparent to those skilled in the art from this disclosure.

For example, an MIHF is included in each of the mobile communication terminal 100 and the mobile router 200, or each of the video streaming server 40, the mobile communication terminal 100 and the mobile router 200, in the above-described embodiment. However, such an alternative is also possible that an MIHF is only provided in the mobile communication terminal 100 and an MIH user is employed instead of a communication application.

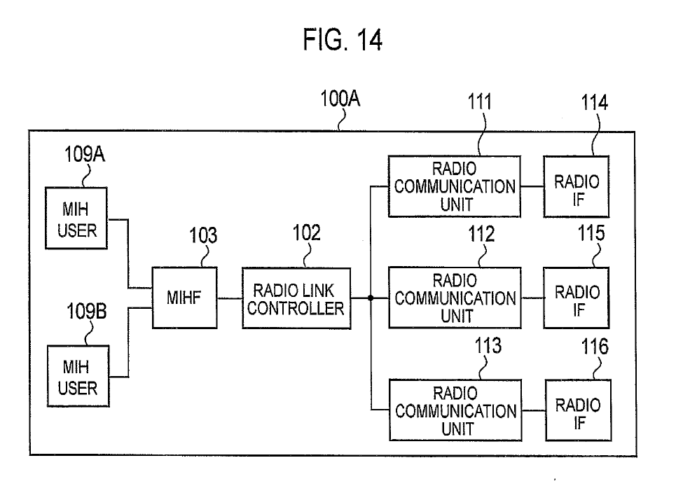

FIG. 14 is a functional block diagram of a mobile communication terminal 100A (radio communication terminal) according to a modification of the present invention. As shown in FIG. 12, the mobile communication terminal 100A includes a radio link controller 102, an MIHF 103, MIH Users 109A and 109B, radio communication units 111 to 113 and radio IFs 114 to 116. In the following, descriptions will be mainly given of aspects different from the above-described mobile communication terminal 100.

The radio communication units 111 to 113 perform radio communication through each of IFs 114 to 116 with radio communication networks 10 to 30, respectively. This means that the mobile communication terminal 100A accesses the radio communication networks 10 to 30 without using a mobile router 200.

On the basis of an instruction from the MIHF 103, the radio link controller 102 controls the radio communication units 111 to 113, and thereby establishes a radio link RL with any one of the radio communication networks 10 to 30.

The MIH User 109A and the MIH User 109B manage the mobility of the mobile communication terminal 100A from the radio communication network 10 to the radio communication network 20, for example. In this modification, the MIH User 109A and the MIH User 109B serve as mobility managers (entities). The MIH User 109A and the MIH User 109B are MIH users defined in IEEE802.21. The MIH User 109A and the MIH User 109B are Mobile IP protocols, for example.

As the above-described communication applications (the video streaming client 105 and the video phone 107), the MIH User 109A and the MIH User 109B transmit MIH_USER_Register.request and receive MIH_USER_Register.response from the MIHF 103. In addition, the MIH User 109A and the MIH User 109B transmit MIH_Get_Service_Quality.request to the MIHF 103. On the basis of the request from the MIH User 109A or the MIH User 109B, the MIHF 103 adaptively controls handover to a different radio communication network or a parameter. Furthermore, the MIHF 103 calculates a prediction value of uplink and downlink service qualities.

In the above-described embodiment, the MIHF 203 has a function of calculating a prediction value of service quality. However, the MIHF 203 does not necessarily have such function. Moreover, in the above-described embodiment, descriptions are given by using a prediction value of downlink service quality as an example. However, such a case is also possible that a video phone of the CN 45 includes an MIHF and the video phone of the CN 45 calculates a prediction value of uplink service quality.

In the above-described embodiment, the MIHF 103 and the MIHF 203 notify an entity such as a communication application of registered MIH_USER_ID. However, such notification is not always necessary. Alternatively, by using, as MIH_USER_ID, a value determined on the basis of a time period at which MIH_USER_Register.request is transmitted or received, the MIHF 103 and the MIHF 203 may register the value, for example.

In the above-described embodiment, descriptions are given by using CDMA200 1xEX-DO, iBurst (registered trademark) and mobile WiMAX as examples. However, radio communication methods to which the present invention is applicable are not limited to those, of course. For example, the present invention is also applicable to LTE (Long Term Evolution) system, which is a next-generation cellular system. As has just been described, it is obvious that the present invention includes various embodiments not described herein.

Note that the entire content of Japanese Patent Application No. 2009-077851 (filed on Mar. 26, 2009) is incorporated herein by reference.

### INDUSTRIAL APPLICABILITY

As described above, the present invention is useful for a radio communication such as a mobile communication, since a radio communication system, a radio communication terminal and a method for controlling communication are capable of enabling a handover controller such as MIH functions to definitely and reliably perform communication with each MIH Users, even when multiple MIH Users exist for a single handover controller.

1. A radio communication system which performs handover from a first radio communication network to a second radio communication network employing a radio communication method different from the radio communication method of the first radio communication network, comprising:
a link controller configured to establish a radio link with the first radio communication network or the second radio communication network;
a plurality of entities each configured to use at least one of the first radio communication network and the second radio communication network; and
a handover controller configured to control handover from the first radio communication network to the second radio communication network on the basis of a request from any one of the entities, wherein
each of the entities transmits a registration request which requests registration of the entity, to the handover controller, and
the handover controller registers the entity which has transmitted the registration request and an entity identifier which identifies the entity, while associating the entity with the entity identifier, on the basis of the registration request received from the entity.

2. The radio communication system according to claim 1, wherein
the handover controller notifies the entity which has transmitted the registration request, of the registered entity identifier, and
the entity transmits a command to the handover controller, the command including the entity identifier notified from the handover controller.

3. The radio communication system according to claim 1, wherein
each of the entities is a mobility manager configured to manage mobility of the radio communication system from the first radio communication network to the second radio communication network, or a communication application configured to perform communication by using at least one of the first radio communication network and the second radio communication network.

4. The radio communication system according to claim 3, wherein
the mobility manager is an MIH user which is defined in IEEE802.21, and
the handover controller is an MIH function which is defined in the IEEE802.21.

5. The radio communication system according to claim 3, wherein
the handover controller is configured to
register the entity identifier, while specifying whether the entity is the communication application or not, and
calculate a prediction value of future service quality to be used by the entity, on the basis of communication quality of the radio link reported from the link controller, and also notifies the entity of the calculated prediction value.

6. A radio communication terminal which performs handover from a first radio communication network to a second radio communication network employing a radio communication method different from that of the first radio communication network, comprising:
a link controller configured to establish a radio link with the first radio communication network or the second radio communication network;
a plurality of entities each configured to use at least one of the first radio communication network and the second radio communication network; and
a handover controller configured to control handover from the first radio communication network to the second radio communication network on the basis of a request from any one of the entities, wherein
each of the entities transmits a registration request which requests registration of the entity, to the handover controller, and
the handover controller registers the entity which has transmitted the registration request and an entity identifier which identifies the entity, while associating the entity with the entity identifier, on the basis of the registration request received from the entity.

7. The radio communication terminal according to claim 6, wherein
the handover controller notifies the entity which has transmitted the registration request, of the registered entity identifier, and
the entity transmits a command to the handover controller, the command including the entity identifier notified from the handover controller.

8. The radio communication terminal according to claim 6, wherein each of the entities is
a mobility manager configured to manage mobility of the radio communication system from the first radio communication network to the second radio communication network, or a communication application configured to perform communication by using at least one of the first radio communication network and the second radio communication network.

9. The radio communication terminal according to claim 8, wherein
the mobility manager is an MIH user which is defined in IEEE802.21, and
the handover controller is an MIH function which is defined in the IEEE802.21.

10. The radio communication terminal according to claim 8, wherein the handover controller
registers the entity identifier, while specifying whether the entity is the communication application or not, and
calculates a prediction value of future service quality to be used by the entity, on the basis of communication quality of the radio link reported from the link controller, and also notifies the entity of the calculated prediction value.

11. A communication controlling method for performing handover from a first radio communication network to a second radio communication network employing a radio communication method different from that of the first radio communication network, comprising the steps of:
establishing a radio link with the first radio communication network or the second radio communication network; and
controlling handover from the first radio communication network to the second radio communication network on the basis of a request from any one of a plurality of entities each of which uses at least one of the first radio communication network and the second radio communication network, wherein
the step of controlling the handover includes the steps of:
transmitting a registration request which requests registration of the entity, to a handover controller; and
registering the entity which has transmitted the registration request and an entity identifier which identifies the entity, while associating the entity with the entity identifier, on the basis of the registration request received from the entity, and notifying the entity which has transmitted the registration request, of the registered entity identifier.
